(19) United States
(12) Patent Application Publication
(10) Pub. No.: US 2002/0034377 A1
(43) Pub. Date: Mar. 21, 2002

(54) System and method for reproducing moving images

(75) Inventor: Kohji Numata, Tokyo (JP)

Correspondence Address: SUGHRUE, MION, ZINN, MACPEAK & SEAS, PLLC, 2100 Pennsylvania Avenue, N.W., Washington, DC, 20037-3202, US

(73) Assignee: NEC CORPORATION

(21) Appl. No.: 09/955,125

(22) Filed: Sep. 19, 2001

(30) Foreign Application Priority Data
Sep. 21, 2000 (JP) 2000-287346

(51) Int. Cl. H04N 5/76

(52) U.S. Cl. 386/111; 386/112

(57) ABSTRACT

A moving image reproduction system and method is provided that monitors the display period of a display and smoothly reproduces moving images. A video decoder reads out compressed image data from a memory, encodes the compressed image data every one frame, and stores decoded image data into the frame buffer. An image storage buffer switch changes its mode every time image data for one frame is decoded and controls so as to always store a previously decoded image and a currently decoded image into a frame buffer memory. A display controller switches plural buffers to be displayed during the next vertical blanking period after reception of the display changeover specification, thus displaying image data on the display. A timing adjuster acquires a current scanning line from the display controller and adjusts the timing with which the display changeover specification is issued in accordance with the scanning line value.

### BACKGROUND OF THE INVENTION

The present invention relates to a technique of reproducing moving images. More particularly, the present invention relates to a moving image reproducing system and method that monitors the display period of a display and smoothly reproduces moving images.

The configuration embodying a conventional moving image reproduction method is shown in FIG. 8. Referring to FIG. 8, the configuration is configured of a storage 80, a video decoder 81, an image storage buffer switch 82, a frame buffer 83, a display buffer switch 84, a display controller 86, and a timepiece 87.

Referring to FIG. 8, the frame buffer 83 is formed of plural buffers. The display buffer switch 84 selects one of the plural buffers 1, 2, 3, . . . in accordance with the vertical blanking period VSYNC. The display controller 86 controls a display (not shown) that can display 60 frames per second. The conventional moving image reproduction method can display 30 video frames per second.

However, in the conventional moving image reproduction method, the video decoder 81 refers to time information from the timepiece 87 and adjusts the timing with which display changeover specification is issued, without synchronizing with the display period of the display (not shown). For that reason, the problem is that a deviation occurs between the timing for display changeover specification and the display period of the display (not shown). Moreover, when the timing with which the video decoder 81 specifies display changeover is not stable, the display period may be lengthened or shortened as shown in FIG. 5A, so that smooth reproduction cannot be realized.

### SUMMARY OF THE INVENTION

The present invention is made to solve the above-mentioned problems. An object of the present invention is to provide a moving image reproduction system that monitors the display period of a display and smoothly reproduces moving images.

Another object of the present invention is to provide a moving image reproduction method that monitors the display period of a display and smoothly reproduces moving images.

In order to achieve the above-mentioned objects, according to the present invention, a moving image reproduction system comprises means for acquiring a scanning line value of a display and adjusting a timing for display changeover specification.

Moreover, according to the present invention, a moving image reproduction system comprises means for acquiring, when one frame is divided two half fields for displaying, a display scanning line value and adjusting the timing of display changeover specification to display a half field to be previously displayed.

According to the present invention, a moving image reproduction system comprises means for smoothly reproducing moving image data by adjusting the timing with which display changeover specification is issued, based on a current scanning line value.

According to the present invention, a moving image reproduction system comprises means for adjusting the display timing of a half field to be previously displayed, with the display scanning line value.

The moving image reproduction system of the present invention further comprises a frame buffer including a plurality of buffers; a storage for storing moving image data compressive encoded in a predetermined image compression encoding scheme; a video decoder for reading out compressed image data from the storage, decoding the compressed image data every one frame, and storing decoded image data into the frame buffer; an image storage buffer switch for switching its mode every time image data for one frame is decoded and controlling so as to always store a previously decoded image and a currently decoded image into the buffer memory; a display controller for switching between the plural buffers, to be displayed during the next vertical blanking period, after reception of the display changeover specification and displaying image data on the display; and a timing adjuster for acquiring a current scanning line from the display controller and adjusting the timing with which the display changeover specification is issued, in accordance with the scanning line value.

In the moving image reproduction system of the present invention, the storage stores compressed image data; and the frame buffer stores moving image data decoded by the video decoder; and the plural buffers, specified by the image storage buffer switch, stores moving image data decoded by the video decoder; and the timing adjuster acquires a current scanning line from the display controller and adjusts the timing with which the display changeover specification is issued, in accordance with the current scan line; and the display controller switches between the plural buffers to be displayed during the next vertical blanking period after reception of the display changeover specification and then displays an image on the display.

The moving image reproduction system of the present invention, further comprises a frame buffer including a plurality of buffers; a storage for storing moving image data compressive encoded in a predetermined image compression encoding scheme; a video decoder for reading out compressed image data from the storage, decoding the compressed image data every one frame, and storing decoded image data into the frame buffer; an image storage buffer switch for switching its mode every time image data for one frame is decoded and controlling so as to always store a previously decoded image and a currently decoded image into the buffer memory; a display controller for switching between the plural buffers to be displayed during the next vertical blanking period and displaying image data on the display, after reception of the display changeover specification; and a timing adjuster for acquiring a scanning line, currently being drawn by the display, from the display controller and adjusting the timing with which the display changeover specification is issued, in accordance with the scanning line value.

In the moving image reproduction system of the present invention, the storage stores compressed image data; and the frame buffer stores moving image data decoded by the video decoder; and the plural buffers, specified by the image storage buffer switch, stores moving image data decoded by the video decoder; and the timing adjuster acquires a scanning line currently being drawn by the display, from the display controller, and adjusts the timing with which the display changeover specification is issued, in accordance with the current scan line; and the display controller switches between the plural buffers to be displayed during the next vertical blanking period after reception of the display changeover specification and displaying an image on the display.

Another aspect of the present invention, a moving image reproduction method comprises the steps of acquiring a display scanning line value; and adjusting the timing of display changeover specification.

Another aspect of the present invention, a moving image reproduction method comprises the steps of acquiring, when one frame is divided two half fields for displaying, a display scanning line value to display a half field to be previously displayed; and adjusting the timing of display changeover specification.

Another aspect of the present invention, a moving image reproduction method comprises the steps of adjusting the timing with which display changeover specification is issued, based on a current scanning line value; and smoothly reproducing moving image data.

Another aspect of the present invention, a moving image reproduction method comprises the steps of adjusting the display timing of a half field to be previously displayed, in accordance with the display scanning line value.

The moving image reproduction method of the present invention further comprises the steps of storing moving image data compressive encoded in a predetermined image compression encoding scheme, into a memory; reading out compressed image data from the memory, decoding the compressed image data every one frame, and storing decoded image data into a frame buffer using a video decoder, the frame buffer including a plurality of buffers; switching its mode every time image data for one frame is decoded and controlling, using an image storage buffer switch, so as to always store a previously decoded image and a currently decoded image into the buffer memory; switching between the plural buffers to be displayed during the next vertical blanking period after reception of the display changeover specification and displaying image data on the display; and acquiring, using a timing adjuster, a current scanning line from the display controller and adjusting the timing with which the display changeover specification is issued, in accordance with the scanning line value.

The moving image reproduction system of the present invention further comprises the steps of storing compressed moving image data using the memory; storing moving image data decoded by the video decoder, into the frame buffer; storing moving image data decoded in the video decoder into plural buffers specified by the image buffer changeover switch; acquiring a current scanning line from the display controller and adjusting the timing with which the display changeover specification is issued, in accordance with the current scanning line, by means of the timing adjuster; and switching between the plural buffers to be displayed during the next vertical blanking period, by means of the display controller, after reception of the display changeover specification and then displaying an image on the display.

The moving image reproduction system of the present invention further comprises storing moving image data compressive encoded in a predetermined image compression encoding scheme, into a memory; reading out compressed image data from the memory, decoding the compressed image data every one frame, and storing decoded image data into a frame buffer by means of a video decoder, the frame buffer including a plurality of buffers; switching its mode every time image data for one frame is decoded and controlling so as to always store a previously decoded image and a currently decoded image into the frame buffer, by means of an image storage buffer switch; switching between the plural buffers to be displayed during the next vertical blanking period after reception of the display changeover specification and displaying image data on the display, by means of a display controller; and acquiring a scanning line, currently being drawn by the display, from the display controller and adjusting the timing with which the display changeover specification is issued in accordance with the scanning line value, by means of a timing adjuster.

The moving image reproduction system of the present invention further comprises the steps of storing compressed moving image data by means of a storage; storing moving image data decoded by the video decoder into the frame buffer; storing moving image data decoded by the video decoder into plural buffers specified by the image storage buffer switch; acquiring, by means of the timing adjuster, a scanning line currently being drawn by the display, from the display controller, and adjusting the timing with which the display changeover specification is issued in accordance with the current scanning line; and switching, by means of the display controller, between the plural buffers to be displayed during the next vertical blanking period after reception of the display changeover specification and then displaying an image on the display.

### BRIEF DESCRIPTION OF THE DRAWINGS

This and other objects, features and advantages of the present invention will become more apparent upon a reading of the following detailed description and drawings, in which:

FIG. 1 is a functional block diagram illustrating a moving image reproduction system according to a first embodiment of the present invention;

FIG. 2 is a flowchart explaining the moving image reproduction method according to the first embodiment of the present invention;

FIG. 3A to FIG.3C are graphs plotting the relationship between frames reproduced at a moving image reproduction time and scanning line values acquired after each frame decoding;

FIG. 4 is a graph plotting the relationship between a reproduced frame and a scanning line value when a scanning line value is acquired immediately before display changeover specification;

FIG. 5A and FIG. 5B are signal diagrams explaining a display time for each frame;

FIG. 6 is a flowchart explaining a moving image reproduction method according to the second embodiment of the present invention;

FIG. 7A and FIG. 7B are signal diagrams explaining a display time for each frame; and

FIG. 8 is a diagram illustrating the configuration of a conventional moving image reproduction method.

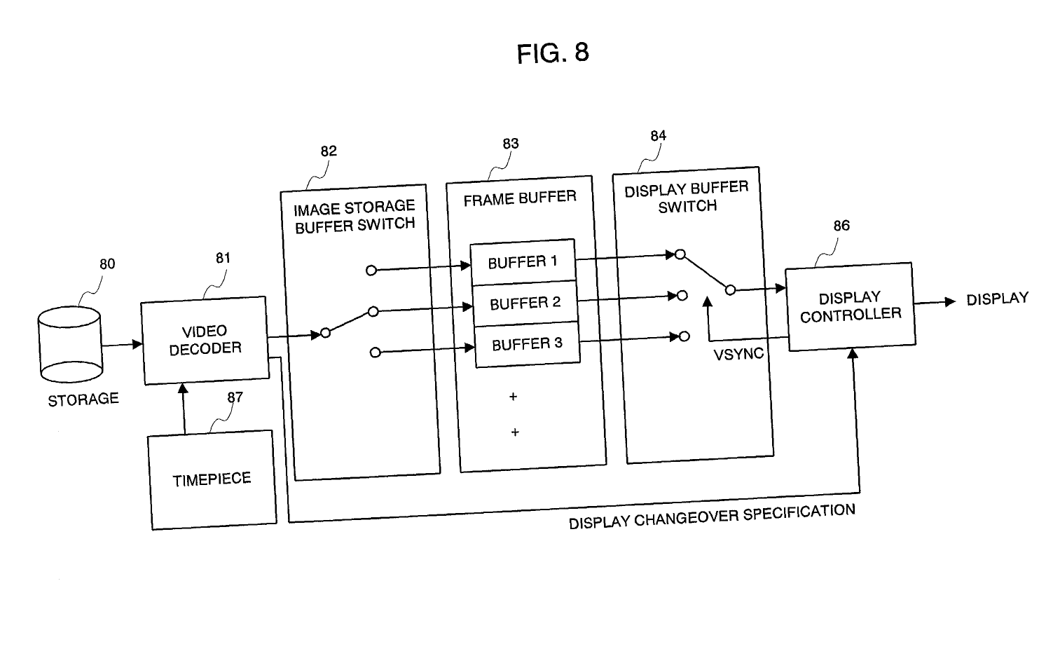

### DESCRIPTION OF THE EMBODIMENTS

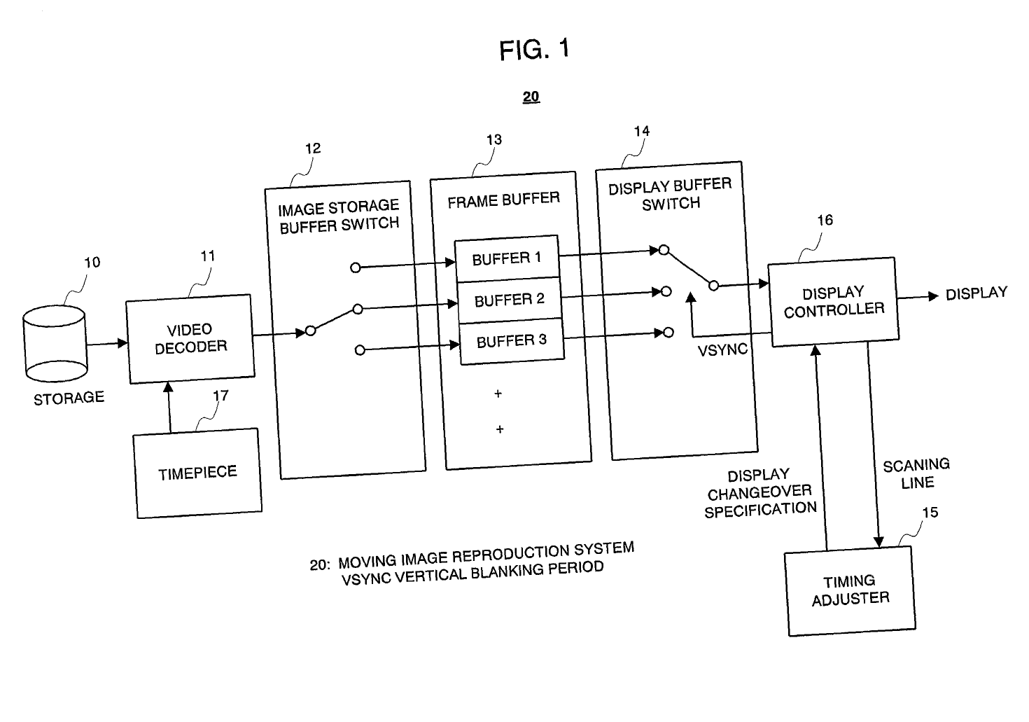

The first embodiment of the present invention will be described below by referring to the attached drawings. FIG. 1 is a functional block diagram illustrating a moving image reproduction system 20 according to the first embodiment of the invention. Referring to FIG. 1, the system 20 consists of a storage 10, a video decoder 11, an image storage buffer switch 12, a frame buffer 13 formed of buffers 1, 2 and 3, a display buffer switch 14, a timing controller 15, a display controller 16, and a timepiece 17. VSYNC represents a vertical blanking period.

The frame buffer 13 includes two or more buffers (buffers 1, 2, 3, . . . ). The storage 10 stores moving image data compressive encoded in the MPEG scheme (a predetermined image compressive encoding scheme).

The video decoder 11 reads compressed image data from the storage 10 to decode it every one frame. The video decoder 11 stores decoded image data into the frame buffer 13 via the image storage buffer switch 12.

The image storage buffer switch 12 is switched every time image data for one frame is decoded. The image storage buffer is controlled so as to always store a previously-decoded image and a currently-decoded image into the frame buffer 13.

The timing adjuster 15 acquires a current scanning line (a scanning line currently drawn by the display (not shown)) from the display controller 16 and adjusts the timing with which display changeover specification is issued, in accordance with the scanning value.

The display controller 16 selects a buffer (buffer 1, 2, 3, or . . . ) to be displayed during the next vertical blanking period (VSYNC) after reception of display changeover specification and displays it on the display (not shown).

Next, the operation of the moving image reproduction system 20 (or a moving image reproduction method) will be explained below.

Referring to FIG. 1, the storage 10 stores compressed moving image data. The frame buffer 13 stores moving image data decoded by the video decoder 11.

The frame buffer 13 is formed of plural (two or more) buffers 1, 2, 3, . . . . The moving image data decoded by the video decoder 11 is stored into the buffer specified by the image storage buffer switch 12. The timing adjuster 15 acquires a current scanning line (e.g. the scanning line currently drawn by the display (not shown)) from the display controller 16 and adjusts the timing with which display changeover specification is issued, in accordance with the scanning line value.

The display controller 16 selects a buffer (buffer 1, 2, 3, or . . . ) to be displayed during the next vertical blanking period (VSYNC) after reception of display changeover specification and then displays it on the display (not shown).

In the above-mentioned configuration, since the issuance timing for display changeover specification is adjusted based on a current scanning line value, moving image data can be smoothly reproduced.

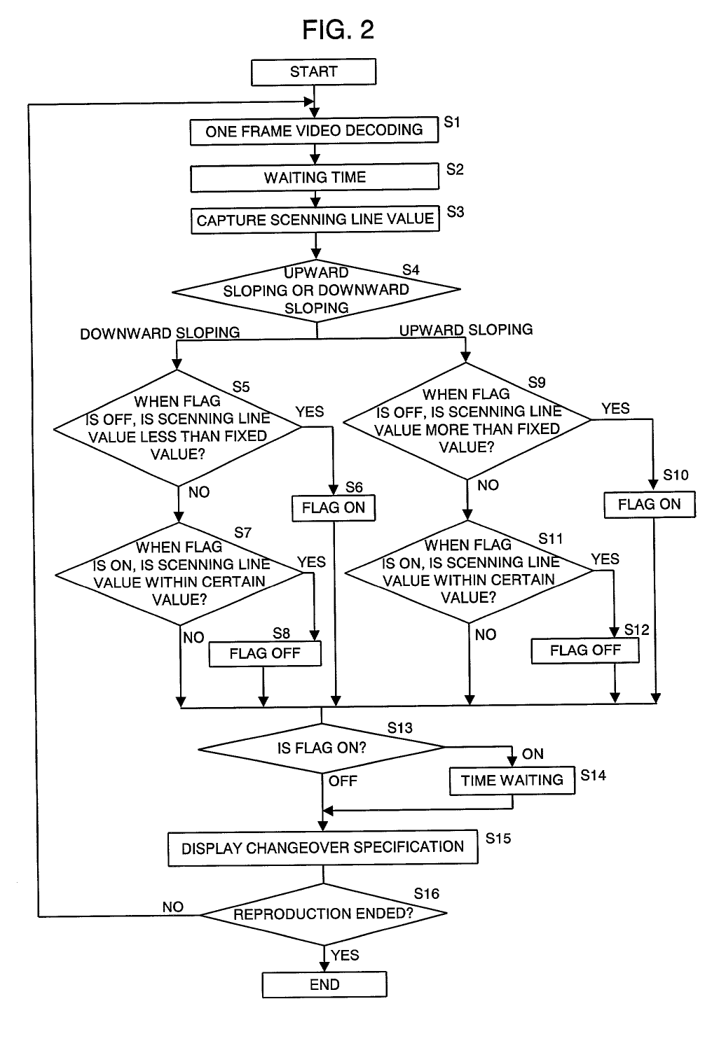

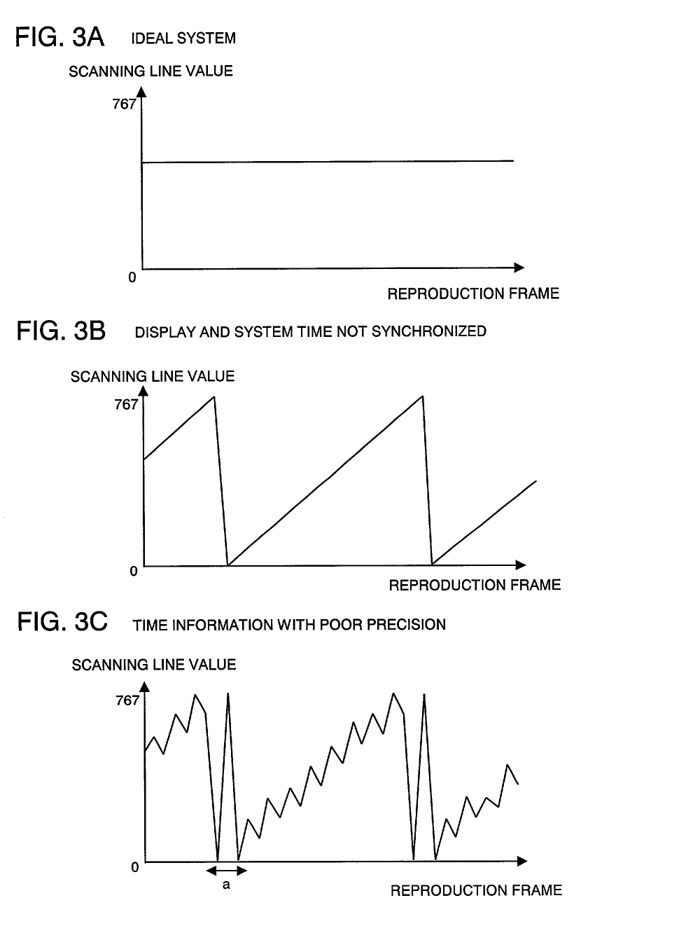

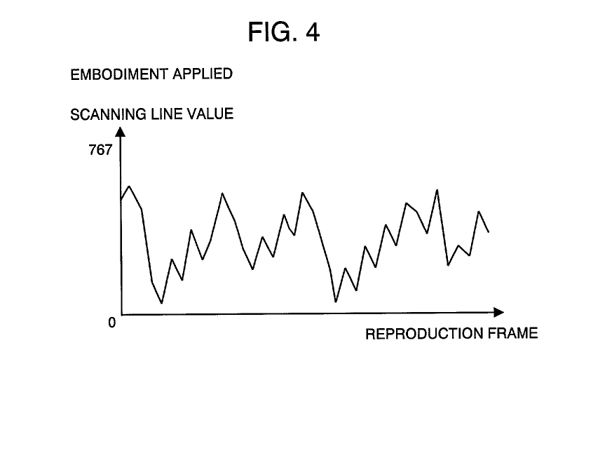

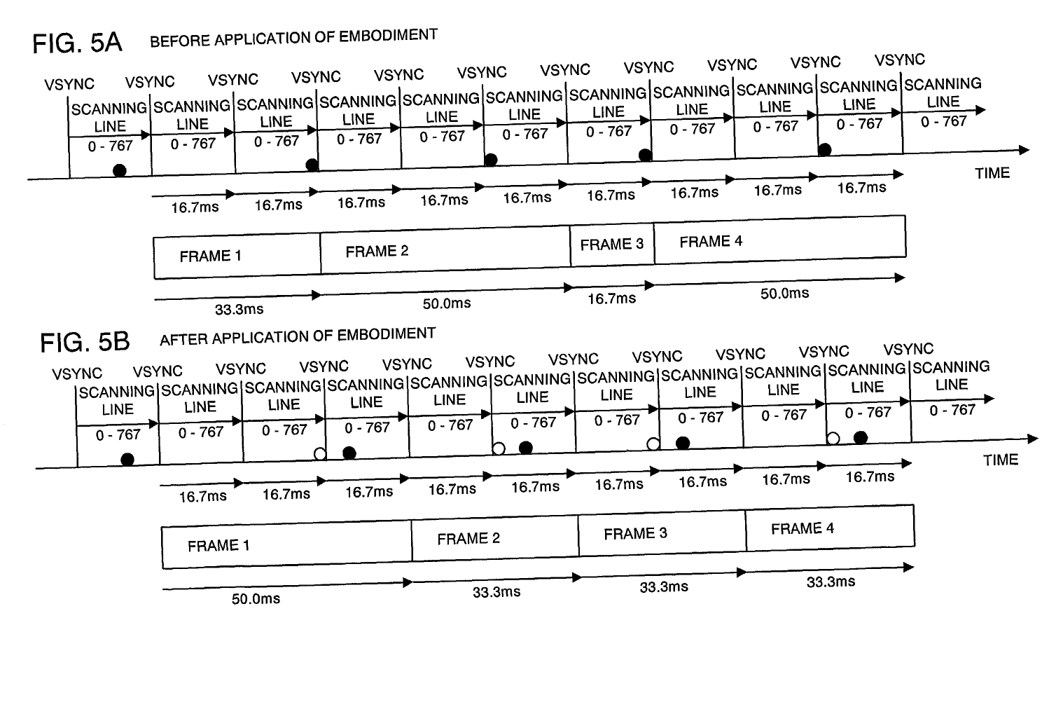

Next, the whole operation of the embodiment will be described below by referring to FIGS. 1 to 5. FIG. 2 is a flowchart explaining a moving image reproduction method according to the first embodiment of the present invention. FIG. 3 is a graph explaining the relationship between a frame reproduced at a moving image reproduction time and a scanning line value acquired after decoding each frame. FIG. 4 is a graph explaining the relationship between a reproduced frame and a scanning line value when a scanning line value is acquired immediately before display changeover specification. FIG. 5 is a signal diagram explaining a display time of each frame. In FIGS. 3 and 4, the horizontal axis represents a reproduction frame. The vertical axis represents a scanning line value.

Referring to FIG. 2, in the step S1, the video decoder 11 reads out compressed moving image data from the storage 10 and decodes video for one frame (one frame video decoding). The decoded image data are sequentially stored into the frame memory 13 via the image storage buffer switch 12. In the frame buffer 13, each buffer (buffer 1, 2, 3, or . . . ) is formed in a ring buffer configuration. In this embodiment, when there are three buffers 1, 2 and 3, data is stored frame by frame in the order of frames 1, 2, 3, 1, . . . .

In the step S2, a current system time (time information) is read from the timepiece 17 and the event is waited until the time the display is updated (time waiting). The display updating time means moving image data for displaying 30 frames per second. For example, when the first frame is displayed at the time 0 (zero), the time to update the display in the second frame is about 33 milliseconds and the time to update the display in the third frame is about 67 milliseconds.

In the successive step S3, the timing adjuster 15 acquires a current scanning line value from the display controller 16. Here, the relationship between a frame reproduced at the time of reproducing a moving image and a scanning line value acquired in the step S3 after decoding each frame will be described by referring FIG. 3. In the following explanation, it is assumed that the display (not shown) is changed 60 times per second over the scanning line value between 0 and 767. Moreover, it is assumed that moving images (the transition from 767 to 0 corresponding to the vertical blanking duration VSYNC) are displayed 30 per second.

In an ideal system, since the display (not shown) displays one image twice every time the scanning line is scanned from 0 to 767, the relationship between a reproduced frame and a scanning line value must be as shown in FIG. 3A. When the display (not shown) is not synchronized with the system time, the phenomenon that the scanning line value captured in the step S3 gradually shifts occurs as shown in FIG. 3B. Moreover, when the time information acquired in the step S2 has poor precision and fluctuates, the relationship becomes as shown in FIG. 3C. FIG. 3C shows a graph sloping upward to right. However, in some relationship between the display (not shown) and the system time, the graph may indicate a downward sloping tendency.

In the step S4, it is judged whether or not the system has an upward sloping tendency or a downward sloping tendency in the relationship between the display (not shown) and the system (the moving image reproduction system 20) time. This judging method is not described here. The relationship can be judged because the scanning line value is captured every frames in the step S3.

When the step 4 judges that the relationship is shown as a graph sloping downward to right (“downward sloping” in step S4), it is judged in the step S5 whether or not the timing adjustment flag (merely abbreviated as “flag” in the chart) is OFF and the scanning line value is less than a certain fixed value. In the step S5, the certain fixed value may be about ¼ of a range over which a scanning line changes. For example, when a scanning line value changes between 0 and 767, it is judged whether or not the scanning line value is less than 192.

In the step S5, when it is judged that the timing adjustment flag is in OFF state and that a scanning line value is less than a certain fixed value (“YES” in the step S5), the timing adjustment flag is set to ON (step S6). Thus, the step S13 is executed.

In other case (“NO” in the step S5), it is judged whether or not the timing adjustment flag is ON and the scanning line value is within a fixed range (step S7).

In the step S7, “within a fixed range” corresponds to 2/4 to ¾ of the range over which the scanning line changes. For example, when the scanning line value changes between 0 and 767, it is judged whether or not the scanning line value is within the range between 384 and 576.

In the step S7, when it is judged that the timing adjustment flag is ON and that the scanning line value is within a certain fixed range (“YES” in step S7), the timing adjustment flag is made OFF (step S8). Then the step S13 is executed.

When it is judged that the timing adjustment flag is not ON in the step S7 or that the scanning line value is not within a certain fixed range (“NO” in step S7), the step S13 is executed.

When it is judged that the relationship is shown as a graph sloping upward to right in the step S4 (“upward sloping” in step S4), the step S9 is executed. In the step S9, it is judged whether or not the timing adjustment flag is OFF and the scanning line value exceeds a certain fixed range. In the step S9, the certain fixed value may be ¾ of a range over which a scanning line changes. For example, when the scanning line value changes from zero to 767, it is judged whether or not the certain fixed value exceeds 576.

In the step S9, when it is judged that the timing adjustment flag is OFF and that the scanning line value is more than a certain fixed value (“YES” in step S9), the timing adjustment flag is made ON (step S10). Thus, the step 13 is executed.

When it is judged that the timing adjustment flag is not OFF or that the scanning line value is less than a fixed value (“NO” in step S9), the step S11 is executed.

In the step S11, it is judged whether or not the timing adjustment flag is ON and the scanning line value within a certain fixed range. The certain fixed range may be ¼ to 2/4 of the range over which the scanning line value changes. For example, when the scanning line value changes from 0 to 767, it is judged whether or not the scanning line value is within the range between 192 and 384.

In the step S11, when it is judged that the timing adjustment flag is ON and that the scanning line value is within a certain fixed range (“YES” in step S11), the timing adjustment flag is made OFF (step S12). Thus, the step S13 is executed.

In the step S11, when it is judged that the timing adjustment flag is not ON or that the scanning line value is not within a certain fixed range (“NO” in step S11), the step S13 is executed.

In the step S13, it is checked whether or not the timing adjustment flag is ON. If ON (“ON” in step S13), the process of waiting several milliseconds to adjust the timing (or a time waiting process) is executed in the step S14.

The several seconds in the step S14 may be ¼ to ½ of the time period for which the display (not shown) scans the scanning lines for one frame. For example, when the display (not shown) scans 60 times per second, the waiting time may be about 60 ms.

In the step S13, if the timing adjustment flag is OFF (“OFF” in step S13), the step S14 is skipped but the flow goes to the step S15.

In the step S15, display changeover specification is issued to the display controller 16. In response to the specification, the display controller 16 updates one frame display during the vertical blanking period (VSYNC), after reception of display changeover specification.

In the step S16, it is decided whether or not reproduction has been finished. The process between the steps S1 and S15 is repeated until the end of the reproduction (“NO” in step S16). When the reproduction is over (“YES” in step S16), the process is finished.

When the scanning line value is obtained immediately before display changeover is specified in the step S15 by adjusting the timing in the step S14 (not shown), the relationship between reproduced frame and scanning value is adjusted as shown in FIG. 4.

The display time of each frame is shown in FIG. 5. FIG. 5A is a diagram of showing the range (a) in FIG. 3C on the time axis. In FIG. 5A, symbol ● represents a display changeover specifying time. After the display controller 16 receives display changeover specification, since the displaying is switched during the next vertical blanking duration VSYNC, the display time of each frame fluctuates as shown in FIG. 5A.

The example of using the present embodiment is shown in FIG. 5B. In FIG. 5B, symbol ◯ represents the time at which the display controller 16 captures the scanning line. Symbol ● represents a display changeover specifying time. After the display controller 16 receives display changeover specification, the displaying is changed during the next vertical blanking period VSYNC. Hence, the display time of each frame does not fluctuate, as shown in FIG. 5B.

Even when the time information captured by the system has poor precision and fluctuates, moving images can be smoothly reproduced.

As described above, the embodiment has the advantage in that since the display timing is adjusted by the display scanning line value, moving images can be smoothly reproduced even when the time information captured by the system has poor precision and fluctuates.

Moreover, decoded images can be fully displayed because the display timing in one field to be previously displayed can be adjusted by the scanning line value of the display (not shown).

Next, the second embodiment of the present invention will be described below in detail by referring to the attached drawings.

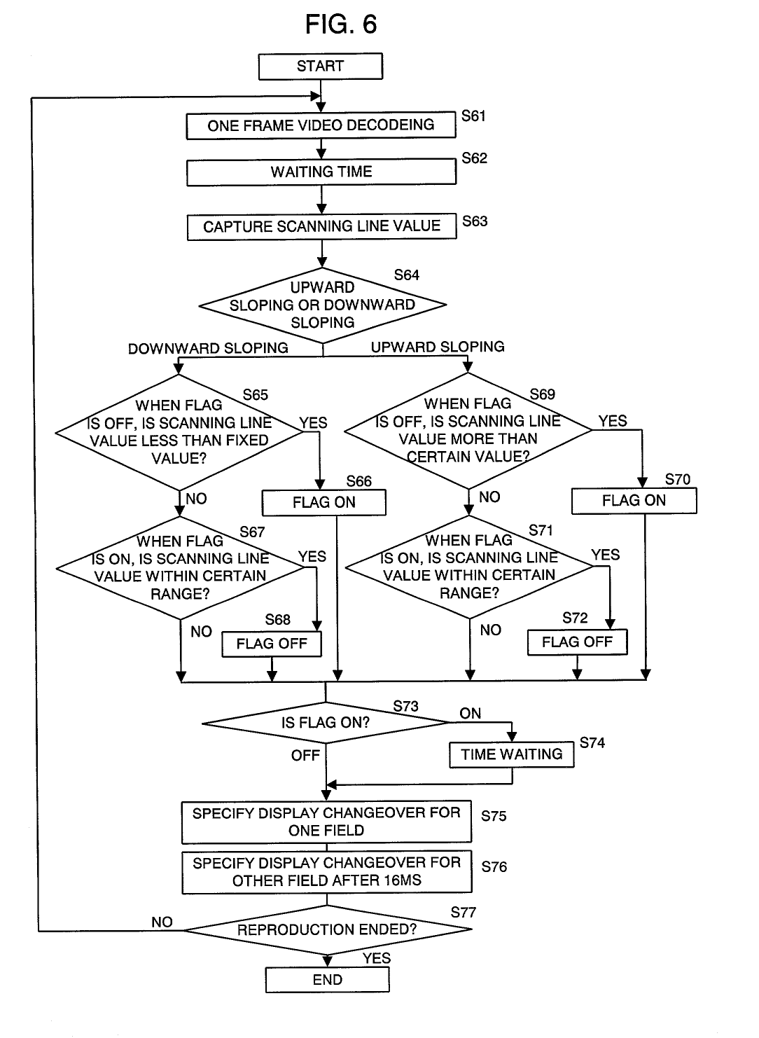

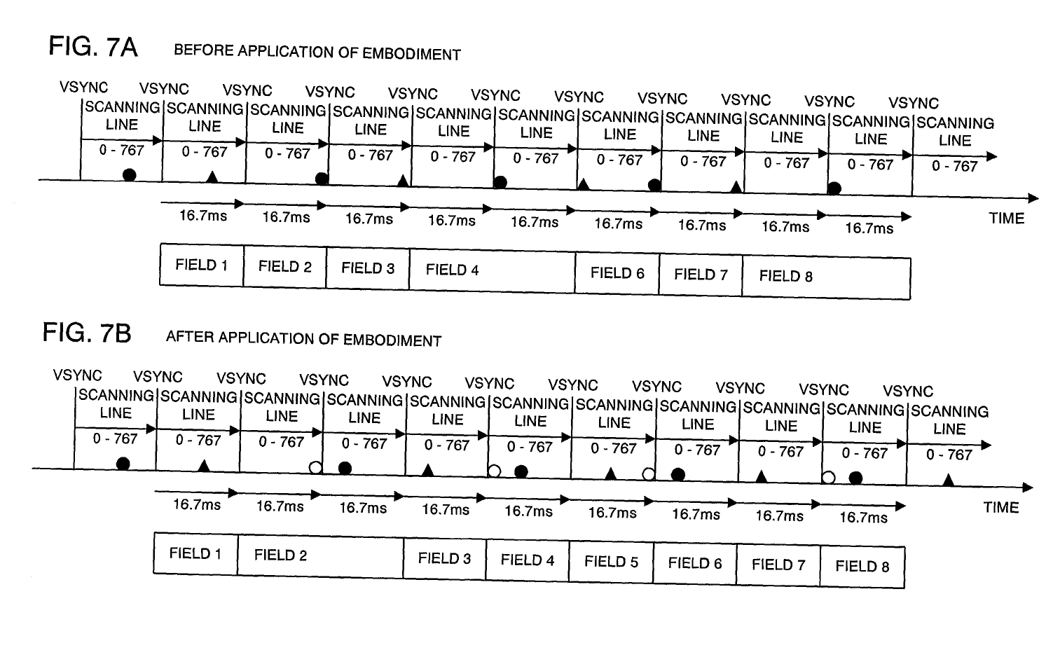

FIG. 6 is a flowchart explaining the moving image reproduction method according to the second embodiment of the invention. FIG. 7 is a signal diagram explaining a display time of each frame. Like numerals are attached to the same constituent elements as those in the first embodiment. Hence duplicate explanation will be omitted here.

In this embodiment, FIG. 6 shows the case where each frame is divided into two fields and 60 fields per second are displayed.

Referring to FIG. 6, in the step S61 after the beginning of a process, the video decoder 11 reads compressed moving image data from the storage 10 and decodes video for one frame (one frame video decoding). Decoded image data are sequentially stored into the frame buffer 13 via the image storage buffer switch 12. Each buffer 1, 2, 3, . . . in the frame buffer 13 has a ring buffer configuration. In this embodiment, decoded image data are sequentially stored into the buffers 1, 2, and 3 frame by frame.

In the step S62, a current system time (time information) is read from the timepiece 17 and the status is waited until the time at which the display is updated comes (time waiting). The display waiting time means moving image data for displaying 30 frames per second. For example, when the first frame is displayed at the time 0, the time at which the display of the second frame is updated is about 33 milliseconds and the time at which the display of the third frame is updated is about 67 milliseconds.

In the step S63, the timing adjuster 15 acquires the current scanning line value from the display controller 16. The relationship between the frame reproduced at a moving image reproduction time and a scanning line value acquired in the step S63 after each frame decoding will be explained below by referring to FIG. 3. It is assumed that the display (not shown) changes 60 times per second and the scanning line value changes from 0 to 767 and 30 moving images per second (the transition from 767 to 0 becomes a vertical blanking duration VSYNC) are displayed.

In an ideal system, the display (not shown) displays an image only twice and one image is displayed every time the scanning line values 0 to 767 are scanned. Hence, the relationship between the reproduced frame and the scanning value must be as shown in FIG. 3. When the system time is not synchronized with the display (not shown), the phenomenon that the scanning line value captured in the step S63 gradually deviates occurs. FIG. 3C shows poor precision and fluctuation of the time information captured in the step S62. FIG. 3C shows a graph sloping up to right. However, in some cases, the relationship between display and system time may be shown as a graph sloping down to right.

In the step S64, it is judged that the moving image reproduction system 20 has a tendency sloping upward or downward to right in the relationship between the display (not shown) and the system time (or time of moving image reproduction system 20). In this decision method, the tendency can be judged (particularly, not described here) because the scanning value is acquired every frames in the step S63.

In the step S64, when the relationship indicates a downward sloping graph (downward sloping to right in step S64), it is judged whether or not the timing adjustment flag in the step S65 is OFF and the scanning line value is less than a certain fixed value. In the step S65, the certain fixed value may be ¼ of the range over which the scanning line changes. For example, when the scanning line value changes between 0 and 767, it is judged whether or not the scanning line is 192 or less.

In the step S65, when it is judged that the timing adjustment flag is OFF and the scanning line value is less than a certain fixed value (“YES” in step S65), the timing adjustment flag is made ON (step S66). Thus, the step S73 is executed.

In other case (“NO” in step S65), it is judged whether or not the timing adjustment flag is ON and the scanning line value is within a certain fixed value (step S67).

The certain fixed value in the step S67 may be 2/4 to ¾ of a range over which the scanning line changes. For example, when the scanning line value changes within 0 and 767, it is judged whether or not the scanning line value is within 384 and 576.

In the step S67, when the timing adjustment flag is ON and the scanning line value is within a certain fixed value (“YES” in step S67), the timing adjustment flag is made OFF (step S68). Then, the step S73 is executed.

When it is judged that the timing adjustment flag is not ON or the scanning line value is not within a certain fixed range (“NO” in step S67), the step S73 is executed.

In the step S64, when it is judged that the relationship is shown as a graph sloping upward to right (“upward sloping to right” in the step S64), the step S69 is executed. In the step S69, it is judged whether or not the timing adjustment flag is OFF and the scanning line value is more than a certain fixed value. In the step S69, the certain fixed value may be ¾ of the range over which the scanning line changes. For example, when the scanning value changes within 0 and 767, it is judged whether or not the scanning line value is 576 or more.

In the step S69, when the timing adjustment flag is OFF and the scanning line value is more than a certain fixed value (“YES” in step S69), the timing adjustment flag is made ON (in step S70). Thus, the step S73 is executed.

When the timing adjustment flag is not OFF or the scanning line value is less than the certain fixed value (“NO” in step S69), the step S71 is executed.

In the step S71, it is judged whether or not the timing adjustment flag is ON and the scanning line value is within a certain fixed range. In the step S71, the certain fixed value may be ¼ to 2/4 of the range over which the scanning line changes. For example, the scanning line changes between 0 and 767, it is judged whether or not the scanning line value is between 192 and 384.

In the step S71, when it is judged that the timing adjustment flag is ON and the scanning line flag is within a certain fixed value (“YES” in step S71), the timing adjustment flag is made OFF (step S72). Thus, the step S73 is executed.

In the step S71, when it is judged that the timing adjustment flag is not ON or that the scanning line value is not within a certain fixed range (“NO” in step S71), the step S73 is executed.

In the step S73, it is checked whether or not the timing adjustment flag is ON. If ON (“NO” in step S73), the step S74 is executed. Thus, the process of waiting only several seconds (time waiting process) is executed to adjust the timing.

Several minutes above-mentioned may be ¼ to ½ of the time period for which the display (not shown) scans the scanning lines for one frame. For example, when the display scans 60 cycles per second, about 6 milliseconds may be suitable.

In the step S73, when the timing adjustment flag is OFF (“OFF” in step S73), the flow goes to the step S75 by skipping the step S74.

In the step S75, display changeover is specified for one field in one buffer (1, 2, 3, or . . . ). After 16 milliseconds, display changeover is specified for the other field in the same buffer (1, 2, 3, or . . . ) (step S76).

In the present embodiment, after the end of the step S76, the next frame is decoded. However, before the display changeover specification for the other field in the step S76 completes, the next frame may be decoded. In such a case, display changeover specification is performed for the other field during frame decoding.

In the step S77, it is judged whether or not reproduction has completed. Until completion of the reproduction (“NO” in step S77), the process ranging from the step S61 to the step S76 is repeated. When the reproduction ends (“YES” in step S77), the process ends.

FIG. 7 shows a display time of each frame to display 60 fields per second. FIG. 7A shows the example where the present embodiment is not applied. In FIG. 7A, symbol ● represents the time at which display changeover of one field is specified. Symbol ▴ represents the time at which display changeover of the other field is specified. Because the display controller 16 changes the display during the next vertical blanking period VSYNC after reception of a display changeover specification, there are fields not shown in FIG. 7A.

FIG. 7B shows the example that the present embodiment is applied. Symbol ◯ represents the time at which the scanning line is obtained from the display controller 16. Symbol ● represents the time at which display changeover one field is specified. Symbol A represents the time at which display changeover the other field is specified. Since the display controller 16 changes the display during the next vertical blanking period VSYNC after reception of a display changeover specification, the display time of each frame is shown in FIG. 7B so that all fields are shown.

As described above, the present embodiment has an advantage similar to that in the first embodiment.

It should be noted that the present invention is not restricted only to the above mentioned embodiments. It is apparent that the above-mentioned embodiments may be suitably modified within the scope of the technical concept of the present invention. The number of the above-mentioned constituent elements, positions thereof, shapes thereof, and the like, are not limited by the aspects of the above-mentioned embodiments. A suitable number of constituent elements, suitable positions thereof, suitable shapes thereof, and the like, may be applicable to embody the present invention. In the attached drawings, like numerals are attached to the same constituent elements.

As described above, the present invention has the advantage in that since the display timing is adjusted by the display scanning line value, moving images can be smoothly reproduced even when the time information captured by the system has poor precision and fluctuates.

Moreover, decoded images can be fully displayed since the display timing in one field to be previously displayed is adjusted by the display scanning line value.

The entire disclosure of Japanese Application No. 2000-287346 filed Sep. 21, 2000 including specification, claims, drawings and summary are incorporated herein by reference in its entirely.

What is claimed is:

1. A moving image reproduction system comprising:
means for acquiring a scanning line value of a display and adjusting a timing for display changeover specification.

2. The system defined in claim 1, further comprising:
a frame buffer including a plurality of buffers;
a storage for storing moving image data compressive encoded in a predetermined image compression encoding scheme;
a video decoder for reading out compressed image data from said storage, decoding said compressed image data every one frame, and storing decoded image data into said frame buffer;
an image storage buffer switch for switching its mode every time image data for one frame is decoded and controlling so as to always store a previously decoded image and a currently decoded image into said buffer memory;
a display controller for switching between said plural buffers, to be displayed during the next vertical blanking period, after reception of said display changeover specification and displaying image data on said display; and
a timing adjuster for acquiring a current scanning line from said display controller and adjusting the timing with which said display changeover specification is issued, in accordance with said scanning line value.
The system defined in claim 2, wherein said storage stores compressed image data; and wherein said frame buffer stores moving image data decoded by said video decoder; and wherein said plural buffers, specified by said image storage buffer switch, stores moving image data decoded by said video decoder; and wherein said timing adjuster acquires a current scanning line from said display controller and adjusts the timing with which said display changeover specification is issued, in accordance with the current scan line; and wherein said display controller switches between said plural buffers to be displayed during the next vertical blanking period after reception of said display changeover specification and then displays an image on said display.

4. The system defined in claim 1, further comprising:
a frame buffer including a plurality of buffers;
a storage for storing moving image data compressive encoded in a predetermined image compression encoding scheme;
a video decoder for reading out compressed image data from said storage, decoding said compressed image data every one frame, and storing decoded image data into said frame buffer;
an image storage buffer switch for switching its mode every time image data for one frame is decoded and controlling so as to always store a previously decoded image and a currently decoded image into said buffer memory;
a display controller for switching between said plural buffers to be displayed during the next vertical blanking period and displaying image data on said display, after reception of said display changeover specification; and
a timing adjuster for acquiring a scanning line, currently being drawn by said display, from said display controller and adjusting the timing with which said display changeover specification is issued, in accordance with said scanning line value.

5. The system defined in claim 4, wherein said storage stores compressed image data; and wherein said frame buffer stores moving image data decoded by said video decoder; and wherein said plural buffers, specified by said image storage buffer switch, stores moving image data decoded by said video decoder; and wherein said timing adjuster acquires a scanning line currently being drawn by said display, from said display controller, and adjusts the timing with which said display changeover specification is issued, in accordance with the current scan line; and wherein said display controller switches between said plural buffers to be displayed during the next vertical blanking period after reception of said display changeover specification and displaying an image on said display.

6. A moving image reproduction system comprising:
means for acquiring, when one frame is divided two half fields for displaying, a display scanning line value and adjusting the timing of display changeover specification to display a half field to be previously displayed.

7. The system defined in claim 6, further comprising:
a frame buffer including a plurality of buffers;
a storage for storing moving image data compressive encoded in a predetermined image compression encoding scheme;
a video decoder for reading out compressed image data from said storage, decoding said compressed image data every one frame, and storing decoded image data into said frame buffer;
an image storage buffer switch for switching its mode every time image data for one frame is decoded and controlling so as to always store a previously decoded image and a currently decoded image into said buffer memory;
a display controller for switching between said plural buffers, to be displayed during the next vertical blanking period, after reception of said display changeover specification and displaying image data on said display; and
a timing adjuster for acquiring a current scanning line from said display controller and adjusting the timing with which said display changeover specification is issued, in accordance with said scanning line value.

8. The system defined in claim 7, wherein said storage stores compressed image data; and wherein said frame buffer stores moving image data decoded by said video decoder; and wherein said plural buffers, specified by said image storage buffer switch, stores moving image data decoded by said video decoder; and wherein said timing adjuster acquires a current scanning line from said display controller and adjusts the timing with which said display changeover specification is issued, in accordance with the current scan line; and wherein said display controller switches between said plural buffers to be displayed during the next vertical blanking period after reception of said display changeover specification and then displays an image on said display.

9. The system defined in claim 6, further comprising:
a frame buffer including a plurality of buffers;
a storage for storing moving image data compressive encoded in a predetermined image compression encoding scheme;
a video decoder for reading out compressed image data from said storage, decoding said compressed image data every one frame, and storing decoded image data into said frame buffer;
an image storage buffer switch for switching its mode every time image data for one frame is decoded and controlling so as to always store a previously decoded image and a currently decoded image into said buffer memory;
a display controller for switching between said plural buffers to be displayed during the next vertical blanking period and displaying image data on said display, after reception of said display changeover specification; and
a timing adjuster for acquiring a scanning line, currently being drawn by said display, from said display controller and adjusting the timing with which said display changeover specification is issued, in accordance with said scanning line value.

10. The system defined in claim 9, wherein said storage stores compressed image data; and wherein said frame buffer stores moving image data decoded by said video decoder; and wherein said plural buffers, specified by said image storage buffer switch, stores moving image data decoded by said video decoder; and wherein said timing adjuster acquires a scanning line currently being drawn by said display, from said display controller, and adjusts the timing with which said display changeover specification is issued, in accordance with the current scan line; and wherein said display controller switches between said plural buffers to be displayed during the next vertical blanking period after reception of said display changeover specification and displaying an image on said display.

11. A moving image reproduction system comprising:
means for smoothly reproducing moving image data by adjusting the timing with which display changeover specification is issued, based on a current scanning line value.

12. The system defined in claim 11, further comprising:
a frame buffer including a plurality of buffers;
a storage for storing moving image data compressive encoded in a predetermined image compression encoding scheme;
a video decoder for reading out compressed image data from said storage, decoding said compressed image data every one frame, and storing decoded image data into said frame buffer;
an image storage buffer switch for switching its mode every time image data for one frame is decoded and controlling so as to always store a previously decoded image and a currently decoded image into said buffer memory;
a display controller for switching between said plural buffers, to be displayed during the next vertical blanking period, after reception of said display changeover specification and displaying image data on said display; and
a timing adjuster for acquiring a current scanning line from said display controller and adjusting the timing with which said display changeover specification is issued, in accordance with said scanning line value.

13. The system defined in claim 12, wherein said storage stores compressed image data; and wherein said frame buffer stores moving image data decoded by said video decoder; and wherein said plural buffers, specified by said image storage buffer switch, stores moving image data decoded by said video decoder; and wherein said timing adjuster acquires a current scanning line from said display controller and adjusts the timing with which said display changeover specification is issued, in accordance with the current scan line; and wherein said display controller switches between said plural buffers to be displayed during the next vertical blanking period after reception of said display changeover specification and then displays an image on said display.

14. The system defined in claim 11, further comprising:
a frame buffer including a plurality of buffers;
a storage for storing moving image data compressive encoded in a predetermined image compression encoding scheme;
a video decoder for reading out compressed image data from said storage, decoding said compressed image data every one frame, and storing decoded image data into said frame buffer;
an image storage buffer switch for switching its mode every time image data for one frame is decoded and controlling so as to always store a previously decoded image and a currently decoded image into said buffer memory;
a display controller for switching between said plural buffers to be displayed during the next vertical blanking period and displaying image data on said display, after reception of said display changeover specification; and
a timing adjuster for acquiring a scanning line, currently being drawn by said display, from said display controller and adjusting the timing with which said display changeover specification is issued, in accordance with said scanning line value.

15. The system defined in claim 14, wherein said storage stores compressed image data; and wherein said frame buffer stores moving image data decoded by said video decoder; and wherein said plural buffers, specified by said image storage buffer switch, stores moving image data decoded by said video decoder; and wherein said timing adjuster acquires a scanning line currently being drawn by said display, from said display controller, and adjusts the timing with which said display changeover specification is issued, in accordance with the current scan line; and wherein said display controller switches between said plural buffers to be displayed during the next vertical blanking period after reception of said display changeover specification and displaying an image on said display.

16. A moving image reproduction system comprising:
means for adjusting the display timing of a half field to be previously displayed, with said display scanning line value.

17. The system defined in claim 16, further comprising:
a frame buffer including a plurality of buffers;
a storage for storing moving image data compressive encoded in a predetermined image compression encoding scheme;
a video decoder for reading out compressed image data from said storage, decoding said compressed image data every one frame, and storing decoded image data into said frame buffer;
an image storage buffer switch for switching its mode every time image data for one frame is decoded and controlling so as to always store a previously decoded image and a currently decoded image into said buffer memory;
a display controller for switching between said plural buffers, to be displayed during the next vertical blanking period, after reception of said display changeover specification and displaying image data on said display; and
a timing adjuster for acquiring a current scanning line from said display controller and adjusting the timing with which said display changeover specification is issued, in accordance with said scanning line value.

18. The system defined in claim 17, wherein said storage stores compressed image data; and wherein said frame buffer stores moving image data decoded by said video decoder; and wherein said plural buffers, specified by said image storage buffer switch, stores moving image data decoded by said video decoder; and wherein said timing adjuster acquires a current scanning line from said display controller and adjusts the timing with which said display changeover specification is issued, in accordance with the current scan line; and wherein said display controller switches between said plural buffers to be displayed during the next vertical blanking period after reception of said display changeover specification and then displays an image on said display.

19. The system defined in claim 16, further comprising:
a frame buffer including a plurality of buffers;
a storage for storing moving image data compressive encoded in a predetermined image compression encoding scheme;
a video decoder for reading out compressed image data from said storage, decoding said compressed image data every one frame, and storing decoded image data into said frame buffer;
an image storage buffer switch for switching its mode every time image data for one frame is decoded and controlling so as to always store a previously decoded image and a currently decoded image into said buffer memory;
a display controller for switching between said plural buffers to be displayed during the next vertical blanking period and displaying image data on said display, after reception of said display changeover specification; and
a timing adjuster for acquiring a scanning line, currently being drawn by said display, from said display controller and adjusting the timing with which said display changeover specification is issued, in accordance with said scanning line value.

20. The system defined in claim 19, wherein said storage stores compressed image data; and wherein said frame buffer stores moving image data decoded by said video decoder; and wherein said plural buffers, specified by said image storage buffer switch, stores moving image data decoded by said video decoder; and wherein said timing adjuster acquires a scanning line currently being drawn by said display, from said display controller, and adjusts the timing with which said display changeover specification is issued, in accordance with the current scan line; and wherein said display controller switches between said plural buffers to be displayed during the next vertical blanking period after reception of said display changeover specification and displaying an image on said display.

21. A moving image reproduction method comprising the steps of:
acquiring a display scanning line value; and
adjusting the timing of display changeover specification.

22. The method defined in claim 21, further comprising the steps of:
storing moving image data compressive encoded in a predetermined image compression encoding scheme, into a memory;
reading out compressed image data from said memory, decoding said compressed image data every one frame, and storing decoded image data into a frame buffer using a video decoder, said frame buffer including a plurality of buffers;
switching its mode every time image data for one frame is decoded and controlling, using an image storage buffer switch, so as to always store a previously decoded image and a currently decoded image into said buffer memory;
switching between said plural buffers to be displayed during the next vertical blanking period after reception of said display changeover specification and displaying image data on said display; and
acquiring, using a timing adjuster, a current scanning line from said display controller and adjusting the timing with which said display changeover specification is issued, in accordance with said scanning line value.

23. The system defined in claim 22, further comprising the steps of:
storing compressed moving image data using said memory;
storing moving image data decoded by said video decoder, into said frame buffer;
storing moving image data decoded in said video decoder into plural buffers specified by said image buffer changeover switch;
acquiring a current scanning line from said display controller and adjusting the timing with which said display changeover specification is issued, in accordance with the current scanning line, by means of said timing adjuster; and
switching between said plural buffers to be displayed during the next vertical blanking period, by means of said display controller, after reception of said display changeover specification and then displaying an image on said display.

24. The system defined in claim 21, further comprising:
storing moving image data compressive encoded in a predetermined image compression encoding scheme, into a memory;
reading out compressed image data from said memory, decoding said compressed image data every one frame, and storing decoded image data into a frame buffer by means of a video decoder, said frame buffer including a plurality of buffers;
switching its mode every time image data for one frame is decoded and controlling so as to always store a previously decoded image and a currently decoded image into said frame buffer, by means of an image storage buffer switch;
switching between said plural buffers to be displayed during the next vertical blanking period after reception of said display changeover specification and displaying image data on said display, by means of a display controller; and
acquiring a scanning line, currently being drawn by said display, from said display controller and adjusting the timing with which said display changeover specification is issued in accordance with said scanning line value, by means of a timing adjuster.

25. The system defined in claim 24, further comprising the steps of:
storing compressed moving image data by means of a storage;
storing moving image data decoded by said video decoder into said frame buffer;
storing moving image data decoded by said video decoder into plural buffers specified by said image storage buffer switch;
acquiring, by means of said timing adjuster, a scanning line currently being drawn by said display, from said display controller, and adjusting the timing with which said display changeover specification is issued in accordance with the current scan line; and
switching, by means of said display controller, between said plural buffers to be displayed during the next vertical blanking period after reception of said display changeover specification and then displaying an image on said display.

26. A moving image reproduction method comprising the steps of:
acquiring, when one frame is divided two half fields for displaying, a display scanning line value to display a half field to be previously displayed; and
adjusting the timing of display changeover specification.

27. The method defined in claim 26, further comprising the steps of:
storing moving image data compressive encoded in a predetermined image compression encoding scheme, into a memory;
reading out compressed image data from said memory, decoding said compressed image data every one frame, and storing decoded image data into a frame buffer using a video decoder, said frame buffer including a plurality of buffers;
switching its mode every time image data for one frame is decoded and controlling, using an image storage buffer switch, so as to always store a previously decoded image and a currently decoded image into said buffer memory;
switching between said plural buffers to be displayed during the next vertical blanking period after reception of said display changeover specification and displaying image data on said display; and
acquiring, using a timing adjuster, a current scanning line from said display controller and adjusting the timing with which said display changeover specification is issued, in accordance with said scanning line value.

28. The system defined in claim 27, further comprising the steps of:
storing compressed moving image data using said memory;
storing moving image data decoded by said video decoder, into said frame buffer;
storing moving image data decoded in said video decoder into plural buffers specified by said image buffer changeover switch;
acquiring a current scanning line from said display controller and adjusting the timing with which said display changeover specification is issued, in accordance with the current scanning line, by means of said timing adjuster; and
switching between said plural buffers to be displayed during the next vertical blanking period, by means of said display controller, after reception of said display changeover specification and then displaying an image on said display.

29. The system defined in claim 26, further comprising:
storing moving image data compressive encoded in a predetermined image compression encoding scheme, into a memory;
reading out compressed image data from said memory, decoding said compressed image data every one frame, and storing decoded image data into a frame buffer by means of a video decoder, said frame buffer including a plurality of buffers;
switching its mode every time image data for one frame is decoded and controlling so as to always store a previously decoded image and a currently decoded image into said frame buffer, by means of an image storage buffer switch;
switching between said plural buffers to be displayed during the next vertical blanking period after reception of said display changeover specification and displaying image data on said display, by means of a display controller; and
acquiring a scanning line, currently being drawn by said display, from said display controller and adjusting the timing with which said display changeover specification is issued in accordance with said scanning line value, by means of a timing adjuster.

30. The system defined in claim 29, further comprising the steps of:
storing compressed moving image data by means of a storage;
storing moving image data decoded by said video decoder into said frame buffer;
storing moving image data decoded by said video decoder into plural buffers specified by said image storage buffer switch;
acquiring, by means of said timing adjuster, a scanning line currently being drawn by said display, from said display controller, and adjusting the timing with which said display changeover specification is issued in accordance with the current scan line; and
switching, by means of said display controller, between said plural buffers to be displayed during the next vertical blanking period after reception of said display changeover specification and then displaying an image on said display.

31. A moving image reproduction method comprising the steps of:
adjusting the timing with which display changeover specification is issued, based on a current scanning line value; and
smoothly reproducing moving image data.

32. The method defined in claim 31, further comprising the steps of:
storing moving image data compressive encoded in a predetermined image compression encoding scheme, into a memory;
reading out compressed image data from said memory, decoding said compressed image data every one frame, and storing decoded image data into a frame buffer using a video decoder, said frame buffer including a plurality of buffers;
switching its mode every time image data for one frame is decoded and controlling, using an image storage buffer switch, so as to always store a previously decoded image and a currently decoded image into said buffer memory;
switching between said plural buffers to be displayed during the next vertical blanking period after reception of said display changeover specification and displaying image data on said display; and
acquiring, using a timing adjuster, a current scanning line from said display controller and adjusting the timing with which said display changeover specification is issued, in accordance with said scanning line value.

33. The system defined in claim 32, further comprising the steps of:
storing compressed moving image data using said memory;
storing moving image data decoded by said video decoder, into said frame buffer;
storing moving image data decoded in said video decoder into plural buffers specified by said image buffer changeover switch;
acquiring a current scanning line from said display controller and adjusting the timing with which said display changeover specification is issued, in accordance with the current scanning line, by means of said timing adjuster; and
switching between said plural buffers to be displayed during the next vertical blanking period, by means of said display controller, after reception of said display changeover specification and then displaying an image on said display.

34. The system defined in claim 31, further comprising:
storing moving image data compressive encoded in a predetermined image compression encoding scheme, into a memory;
reading out compressed image data from said memory, decoding said compressed image data every one frame, and storing decoded image data into a frame buffer by means of a video decoder, said frame buffer including a plurality of buffers;
switching its mode every time image data for one frame is decoded and controlling so as to always store a previously decoded image and a currently decoded image into said frame buffer, by means of an image storage buffer switch;
switching between said plural buffers to be displayed during the next vertical blanking period after reception of said display changeover specification and displaying image data on said display, by means of a display controller; and
acquiring a scanning line, currently being drawn by said display, from said display controller and adjusting the timing with which said display changeover specification is issued in accordance with said scanning line value, by means of a timing adjuster.

35. The system defined in claim 34, further comprising the steps of:
storing compressed moving image data by means of a storage;
storing moving image data decoded by said video decoder into said frame buffer;
storing moving image data decoded by said video decoder into plural buffers specified by said image storage buffer switch;
acquiring, by means of said timing adjuster, a scanning line currently being drawn by said display, from said display controller, and adjusting the timing with which said display changeover specification is issued in accordance with the current scan line; and
switching, by means of said display controller, between said plural buffers to be displayed during the next vertical blanking period after reception of said display changeover specification and then displaying an image on said display.

36. A moving image reproduction method comprising the steps of:
adjusting the display timing of a half field to be previously displayed, in accordance with said display scanning line value.

37. The method defined in claim 36, further comprising the steps of:
storing moving image data compressive encoded in a predetermined image compression encoding scheme, into a memory;
reading out compressed image data from said memory, decoding said compressed image data every one frame, and storing decoded image data into a frame buffer using a video decoder, said frame buffer including a plurality of buffers;
switching its mode every time image data for one frame is decoded and controlling, using an image storage buffer switch, so as to always store a previously decoded image and a currently decoded image into said buffer memory;
switching between said plural buffers to be displayed during the next vertical blanking period after reception of said display changeover specification and displaying image data on said display; and
acquiring, using a timing adjuster, a current scanning line from said display controller and adjusting the timing with which said display changeover specification is issued, in accordance with said scanning line value.

38. The system defined in claim 37, further comprising the steps of:
storing compressed moving image data using said memory;
storing moving image data decoded by said video decoder, into said frame buffer;
storing moving image data decoded in said video decoder into plural buffers specified by said image buffer changover switch;
acquiring a current scanning line from said display controller and adjusting the timing with which said display changeover specification is issued, in accordance with the current scanning line, by means of said timing adjuster; and
switching between said plural buffers to be displayed during the next vertical blanking period, by means of said display controller, after reception of said display changeover specification and then displaying an image on said display.

39. The system defined in claim 36, further comprising:
storing moving image data compressive encoded in a predetermined image compression encoding scheme, into a memory;
reading out compressed image data from said memory, decoding said compressed image data every one frame, and storing decoded image data into a frame buffer by means of a video decoder, said frame buffer including a plurality of buffers;
switching its mode every time image data for one frame is decoded and controlling so as to always store a previously decoded image and a currently decoded image into said frame buffer, by means of an image storage buffer switch;
switching between said plural buffers to be displayed during the next vertical blanking period after reception of said display changeover specification and displaying image data on said display, by means of a display controller; and
acquiring a scanning line, currently being drawn by said display, from said display controller and adjusting the timing with which said display changeover specification is issued in accordance with said scanning line value, by means of a timing adjuster.

40. The system defined in claim 39, further comprising the steps of:
storing compressed moving image data by means of a storage;
storing moving image data decoded by said video decoder into said frame buffer;
storing moving image data decoded by said video decoder into plural buffers specified by said image storage buffer switch;
acquiring, by means of said timing adjuster, a scanning line currently being drawn by said display, from said display controller, and adjusting the timing with which said display changeover specification is issued in accordance with the current scan line; and
switching, by means of said display controller, between said plural buffers to be displayed during the next vertical blanking period after reception of said display changeover specification and then displaying an image on said display.
